(19) United States
(12) Patent Application Publication
(10) Pub. No.: US 2026/0309742 A1
(43) Pub. Date: Oct. 8, 2026

(54) MULTICHANNEL PIPETTING SYSTEM

(71) Applicant: GILSON, INC., Middleton, WI (US)

(72) Inventors: Bruno DUDEK, ORRY LA VILLE (FR); Stéphane GUICHARDON, LOUVECIENNES (FR); Fabrice MERY, CHATOU (FR)

(21) Appl. No.: 19/478,814

(22) PCT Filed: Apr. 12, 2024
(86) PCT No.: PCT/EP2024/060078

§ 371 Date: Oct. 26, 2025

(30) Foreign Application Priority Data
May 9, 2023 (FR) FR2304563

(51) Int. Cl. G01N 35/10; B01L 3/02

(52) U.S. Cl. CPC G01N 35/1074; B01L 3/021

(57) ABSTRACT

A pipetting system includes a support having pipetting tips and arranged on a rectangular matrix. A pipetting head includes a casing accommodating pipetting channels arranged on the rectangular matrix. Each pipetting channel has an end piece to press-fittingly co-operate with a pipetting tip to receive or dispense liquid. The pipetting head is movable within a predefined range between a raised position and an engaged position. An actuating lever vertically translates the pipetting head between the raised position and the engaged position in response to a force applied thereto. The actuating lever is rotatable between a rest position and a pivoted position to move the pipetting head from the raised position to the engaged position. A controller controls an axial press-fitting force along the vertical axis of the pipetting tips on the end pieces brought about by the rotation of the actuating lever between the rest position and the pivoted position.

### FIELD OF THE INVENTION

The present invention relates to the field of multichannel pipetting systems, such as multichannel sampling pipettes, also referred to as pipetting systems, laboratory pipetting systems, or laboratory pipettes, or liquid transfer pipettes, for the calibrated sampling and introduction of liquid into containers.

The invention preferably applies to motor-driven or semi-motor-driven pipetting systems, with manual or servo-assisted movement of the pipetting head and motor-driven pipetting, but may also apply to manual pipetting systems.

The invention applies to air displacement or positive displacement pipetting systems.

### STATE OF PRIOR ART

For many years, pipetting systems, whether motor-driven, semi-motor-driven or even manual, have undergone many improvements in design.

From prior art, it is known pipetting systems comprising a pipetting head, a base comprising one or more trays which are to face the pipetting head, and a tower extending from the base and comprising a linear guide rail along which the pipetting head can be moved by a user along a vertical axis relative to the tray.

Conventionally, the pipetting head comprises a plurality of pipetting channels arranged on a rectangular matrix of rows and columns. Each of these pipetting channels is conventionally fitted with a tip to cooperate with a pipette cone, which can be disposable, by fitting so as to receive or dispense liquid.

In order to fit each of these pipette cones onto its respective tip, a user conventionally uses actuation means which can be manual or motor-driven, so as to translate the pipetting head along a vertical axis and direct the tips towards the pipette cones.

However, a drawback of existing pipetting systems, and mostly manual or servo systems, is that it is not possible to ensure that a user properly completes the operation of fitting the pipette cones onto the tips connected to the pipetting head.

Yet, this fitting operation proves to be relatively important for the proper operation of the pipetting system so as to ensure proper hold and proper sealing of the pipette cones while avoiding pressing these pipette cones too strongly, which would have an impact on the ejection force and therefore potentially on ergonomics, in the case of manual ejection, or on the sizing of the motor to be implemented for this ejection, in the case of motor-driven ejection.

There is therefore a need to improve the existing system, and especially to implement a reliable pipetting system that enables the force for fitting pipette cones onto the tips of the pipetting head to be controlled.

### DISCLOSURE OF THE INVENTION

One purpose of the invention is to at least partly overcome the aforementioned drawbacks relating to techniques of prior art.

For this, the invention relates to a pipetting system comprising:
a rack comprising a plurality of pipette cones, said rack being arranged on a rectangular matrix of rows and columns;
a pipetting head comprising a casing housing a plurality of pipetting channels arranged on a rectangular matrix of rows and columns, each of said pipetting channels being provided with a tip to cooperate with one of said pipette cones by fitting so as to receive or dispense liquid, said pipetting head being movable in a predefined range of movement between a raised position in which said tips are distant from said pipette cones and an engaged position in which said pipette cones are fitted onto said tips;
a base comprising at least one tray which is to face said pipetting head and configured to accommodate said rack provided with pipette cones;
a tower extending from said base and comprising a linear guide rail along which the pipetting head can be manually moved along a vertical axis V relative to said base in said at least one predefined range of movement;
an actuation lever rotatably mounted along a horizontal axis H orthogonal to said vertical axis V relative to said base, said actuation lever being configured to vertically translationally drive said pipetting head between said raised position and said engaged position in response to a force applied to said actuation lever, said actuation lever being rotatably movable between at least a rest position and a pivoted position so as to transition said pipetting head from said raised position to said engaged position.

According to the invention, said pipetting system further comprises means for checking an axial force along said vertical axis V for fitting said pipette cones onto said tips caused by the rotation of the actuation lever between the rest position and the pivoted position.

Thus, the invention provides a novel and inventive approach for at least partly solving some of the drawbacks of prior art.

In particular, the implementation of means for checking an axial fitting force makes it possible to improve the reliability of the pipetting system by controlling the force for fitting the pipette cones onto the tips of the pipetting head.

Indeed, such means for checking a fitting force make it possible to ensure that a user properly performs the operation of fitting the pipette cones onto the tips connected to the pipetting head by ensuring that the fitting is sufficiently performed, but not excessively, so that these tips remain in contact with the tips but do not damage the pipetting system.

According to a particular aspect of at least one embodiment of the invention, the means for checking an axial force along said vertical axis V for fitting said pipette cones onto said tips comprise electronic means for checking an axial fitting force. According to a particular aspect of at least one embodiment of the invention, the means for checking an axial force along said vertical axis V for fitting said pipette cones onto said tips comprise a force sensor and a stop capable of at least partially bearing against said force sensor in response to an at least partial rotation of said actuation lever from said rest position to said pivoted position.

This enables the implementation of a pipetting system that is both mechanically simple and reliable.

According to a particular aspect of at least one embodiment of the invention, said tower comprises a rod for picking up movement of said actuation lever, said rod being connected to said actuation lever through drive means, said rod being rotatably movable about said horizontal axis H and pivoting about said horizontal axis H in response to a force applied to said actuation lever, so that a rotation of said actuation lever from said rest position to said pivoted position results in a rotation of said rod and said drive means from a stowed position to a position in which said rod axially bears against said stop and exerts a thrust force on said stop towards said force sensor.

According to a particular aspect of at least one embodiment of the invention, said force sensor is vertically spaced apart from said stop so that a thrust exerted by said rod on said stop is detected from a predetermined value of bearing of said rod against said stop.

According to a particular aspect of at least one embodiment of the invention, the system further comprises retraction means to move said rod away from said pipetting head, when said pipetting head is positioned outside said predefined range of movement.

This prevents the retraction means from moving away the rod backwards if the pipette head is not positioned in the predefined range of movement, thereby preventing it from hitting the pipette head, for example, and damaging it. Only when the pipetting head is properly positioned in the predefined range of movement can said rod axially bear against said stop.

According to a particular aspect of at least one embodiment of the invention, said retraction means comprise a retraction spring configured to exert a force towards a rotation pin representing said horizontal axis H so as to move said rod away from said pipetting head, when said pipetting head is positioned outside said predefined range of movement.

In other words, the retraction spring exerts a force against a rotation pin that represents the axis of rotation, and thus prevents the rotation of the rod about said horizontal axis H when the pipetting head is positioned outside the predefined range of movement.

According to a particular aspect of at least one embodiment of the invention, the pipetting system further comprises monitoring means, provided on said pipetting head and to be positioned opposite said tray.

Such monitoring means may for example comprise a CCD or CMOS camera for checking the number of lines of cones fitted, for checking whether the consumable (which may be the pipette cone rack, the pipette cones, a tank, a microtitre plate) is present or absent from the tray, for checking the position of the tray in the case of a multi-position tray, for checking actions performed (picking of pipette cones, presence of liquid in consumables), or even checking the type of tray installed in the case of a pipetting system with multiple removable or rotating trays.

According to a particular aspect of at least one embodiment of the invention, said stop is at least partially made from deformable plastic or deformable metal.

This thus makes it possible to provide sufficient elasticity to allow the deformation of the stop when the rod exerts an axial force.

According to a particular aspect of at least one embodiment of the invention, the pipetting system further comprises a pipetting motor so as to receive or dispense liquid into said liquid sampling or receiving containers disposed on said tray, and to eject spent pipette cones.

This ejection of pipette cones can be performed by moving a plate.

According to a particular aspect of at least one embodiment of the invention, the pipetting system further comprises means for recognizing a pipette cone rack.

According to a particular aspect of at least one embodiment of the invention, the recognition means comprises a color sensor provided on the tower, facing the plate.

According to a particular aspect of at least one embodiment of the invention, the pipetting system comprises tracking means capable of delivering information belonging to the group comprising:
a number of pipette cones not yet used;
information relating to a protocol step to be performed, in progress, or performed;
information on the presence of a rack on said tray;
information relating to a value representative of a fitting force;
information on the date or time of completion of a fitting and/or pipetting;
a planned maintenance date;
identification information of consumables present on the tray;
identification information of the pipetting system.

According to a particular aspect of at least one embodiment of the invention, said tracking means comprise a microcontroller and display means.

According to a particular aspect of at least one embodiment, the pipetting system is a semi-motor-driven pipetting system.

The invention also relates to a method for fitting pipette cones onto a pipetting system according to one of the aforementioned embodiments, said method comprising a step of pivoting said actuation lever from a rest position to a pivoted position so as to transition said pipetting head from said raised position in which said tips are distant from said pipette cones to said engaged position in which said pipette cones are fitted onto said tips, characterized in that it further comprises a step of checking an axial force along said vertical axis V for fitting said pipette cones onto said tips.

According to a particular aspect of at least one embodiment, the step of checking a fitting force comprises a step of emitting a signal when the fitting force reaches a predetermined threshold.

According to a particular aspect of at least one embodiment of the invention, this signal may be a visual signal, an audible signal or a haptic signal.

Such a signal can be useful to warn a user that they can release the lever.

According to a particular aspect of at least one embodiment, the step of checking a fitting force may also comprise a step of emitting a signal when the actuation lever is released even though the fitting force has not reached a predetermined threshold.

According to a particular aspect of at least one embodiment of the invention, this signal may be a visual signal, an audible signal or a haptic signal.

Such a signal can be useful to prevent a user from releasing the lever too early.

According to a particular aspect of at least one embodiment, the step of checking a fitting force may also comprise a step of sending information to the microcontroller so as to authorize a pipetting operation only if a predetermined fitting force threshold has been reached.

### DESCRIPTION OF THE FIGURES

The invention, as well as the various advantages thereof, will be more easily understood in the light of the following description of an illustrative and non-limiting embodiment thereof, and the appended drawings among which:

FIG. 1 is a perspective view of a pipetting system according to one embodiment of the invention, the actuation lever being in the rest position;

FIG. 2 is a perspective view of the pipetting system of FIG. 1, the actuation lever being in a pivoted position;

FIG. 3 is a perspective view of the pipetting system of FIG. 1, without the casing of the pipetting head;

FIG. 4 is a perspective view of the pipetting system of FIG. 2, without the casing of the pipetting head;

FIG. 5 is a perspective view of a part of the pipetting system of FIG. 2;

FIG. 6 is a side view of FIG. 5;

FIG. 7A is a perspective cross-section view of the pipetting system according to the embodiment of FIG. 1, the actuation lever being in the rest position;

FIG. 7B is a rear perspective view of the pipetting system according to the embodiment of FIG. 7A;

FIG. 7C is a detail view of a part of FIG. 7B;

FIG. 8A is a perspective cross-section view of the pipetting system according to the embodiment of FIG. 1, the actuation lever being in a pivoted position;

FIG. 8B is a rear perspective view of the pipetting system according to the embodiment of FIG. 8A, and

FIG. 8C is a detail view of a part of FIG. 8B.

### DETAILED DESCRIPTION OF ONE EMBODIMENT OF THE INVENTION

The general principle of the invention relies on the implementation of means for checking an axial force along said vertical axis V for fitting said pipette cones onto said tips so as to ensure sealing of these tips relative to these tips, but also so as to ensure that, when fitted, the tips do not damage the tips by incorrect handling by a user (excessive fitting force, for example). Thus, the implementation of means for checking an axial fitting force makes it possible to implement a reliable pipetting system that makes it possible to control the force for fitting the pipette cones onto the tips of the pipetting head by ensuring that the fitting is sufficiently, but not excessively, performed so that the pipette cones remain in contact with the tips but do not damage the pipetting system.

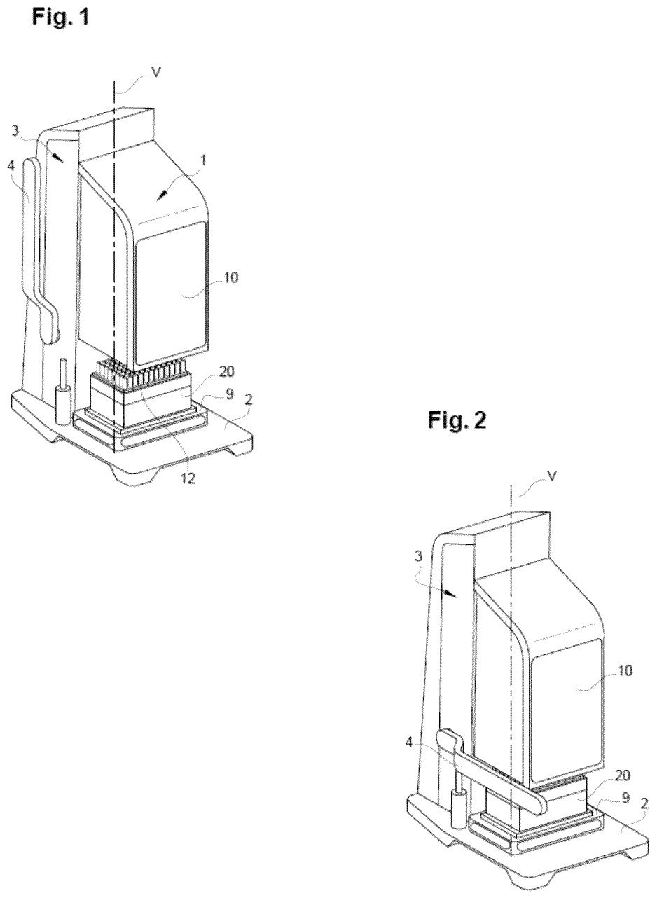

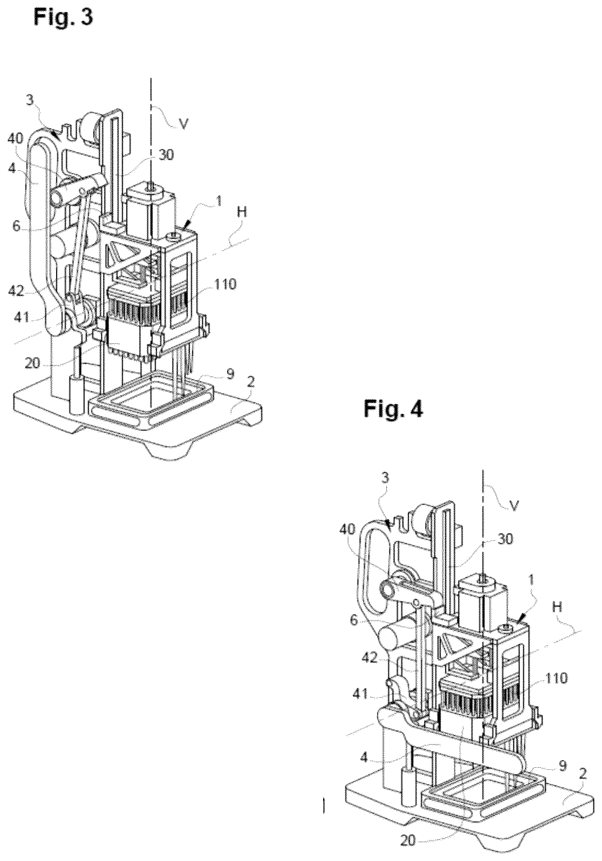

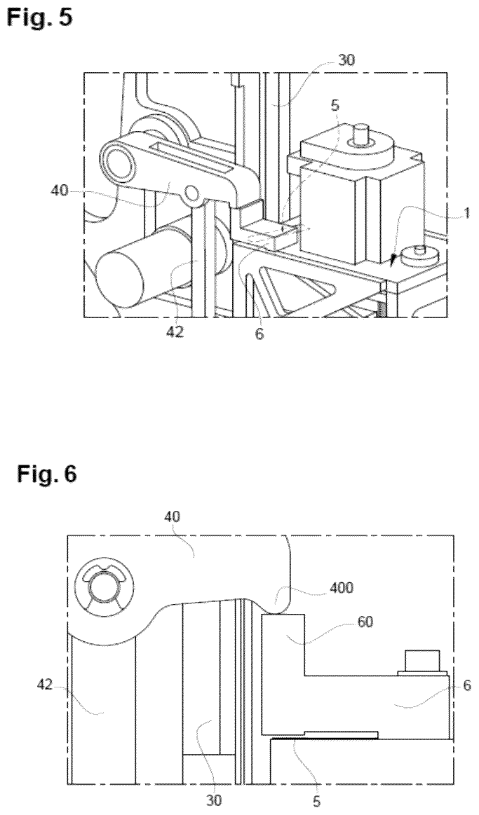

In relation to FIGS. 1 to 8C, one embodiment of the invention is now set forth by way of illustrating, but not limiting purposes.

As illustrated, the pipetting system, which is herein a semi-motor-driven pipetting system, comprises:
a rack 20 provided with a plurality of pipette cones 12, arranged on a rectangular matrix of rows and columns;
a pipetting head 1;
a base 2 comprising at least one tray 9 which is to face the pipetting head 1 and configured to accommodate the rack 20 provided with pipette cones 12;
a tower 3 extending from the base 2 and comprising a linear guide rail 30 along which the pipetting head 1 can be manually moved along a vertical axis V relative to said base 2;
an actuation lever 4 rotatably mounted along a horizontal axis H orthogonal to the vertical axis V relative to the base 2.

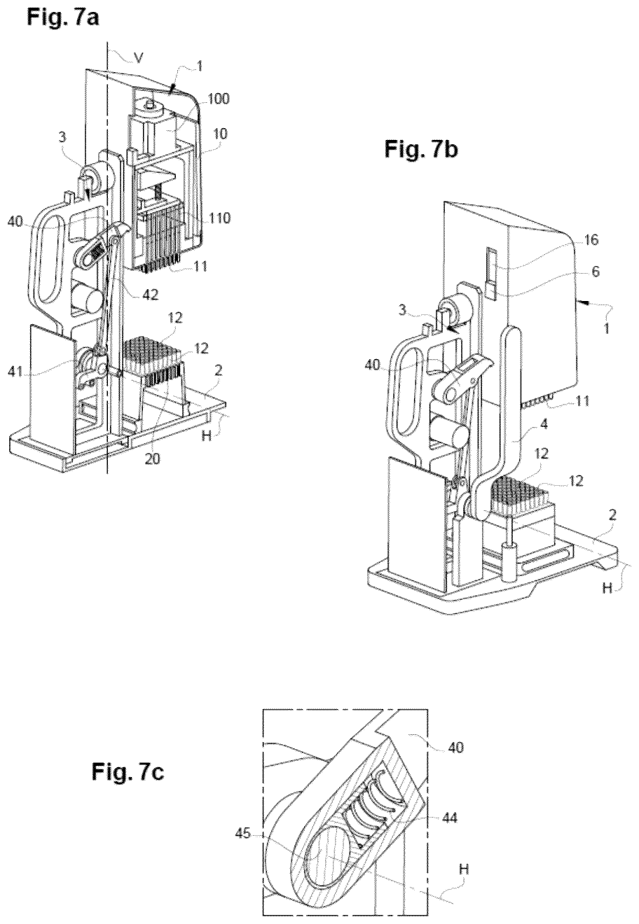

The pipetting head 1 comprises, as especially visible in FIG. 7A, a plurality of pipetting channels arranged on a rectangular matrix of rows and columns, each of the pipetting channels being provided with a tip 11 to cooperate with one of the pipette cones 12 by fitting so as to subsequently receive or dispense liquid into containers provided to this end.

As visible in FIGS. 1 and 2, the pipetting head also comprises a casing 10 so as to protect the various components of this pipetting head from the external environment and therefore from premature wear or breakage.

The pipetting system also comprises a pipetting motor 100 disposed at the pipetting head so as to receive or dispense liquid into the liquid sampling or receiving containers disposed on the tray 9. More particularly, to receive or dispense liquid into the liquid sampling or receiving containers disposed on the tray 9, the motor drives pistons 110 which slide in the pipetting channels provided with tips.

According to the invention, the pipetting head 1 is movable in a predefined range of movement between a raised position in which the tips 11 are distant from the pipette cones 12 and an engaged position in which the pipette cones 12 are fitted onto said tips 11.

In other words, the raised position may especially correspond to a position in which the pipetting head is positioned above, or even almost in contact with, the pipette cones 12, while the engaged position may correspond to a position in which the pipette cones 12 are fitted onto the tips 11.

This predefined range of movement is, in this embodiment, represented by a window 16 formed in the casing 10, more precisely at the rear of the casing.

In the predefined range of movement, this pipetting head 1 is moved through the actuation lever 4 which is configured to vertically translationally drive the pipetting head 1 between the raised position and the engaged position in response to a force applied to the actuation lever 4, for example through a user.

More particularly, the actuation lever 4 is rotatably movable between at least a rest position and a pivoted position so as to transition the pipetting head 1 from the raised position to the engaged position, defined above.

It should be noted that the pipetting head 1 can be manually moved along a vertical axis V relative to said base 2 along the guide rail 30 of the tower 3 in said at least one predefined range of movement.

According to embodiments, the pipetting head may also be manually moved along a vertical axis V relative to said base along the guide rail of the tower in several predefined, consecutive or at least partially identical ranges of movement.

According to the invention, the pipetting system further comprises means for checking an axial force along the vertical axis V for fitting the pipette cones 12 onto the tips 11 caused by the rotation of the actuation lever 4 between the rest position and the pivoted position.

These means for checking an axial force along the vertical axis V for fitting the pipette cones onto the tips may for example comprise electronic means for checking an axial fitting force.

These electronic means for checking an axial fitting force may especially comprise one or more sensors. They may also comprise a switch or a contactor for obtaining information representative of an arrival at a given point. In this embodiment, the means for checking an axial force along the vertical axis V for fitting the pipette cones 12 onto the tips 11 comprise a force sensor 5 and a stop 6 capable of at least partially bearing against the force sensor 5 in response to an at least partial rotation of the actuation lever 4 from the rest position to the pivoted position.

In other words, as the actuation lever is pivoted from the rest position to the pivoted position, the stop 6 will bear on the force sensor more strongly, which will allow the axial force along the vertical axis V for fitting the pipette cones 12 on the tips 11 to be checked.

Still more particularly, in this embodiment, and as illustrated in the various figures, the tower 3 comprises a rod 40 for picking up movement of the actuation lever 4, so that a rotation of the actuation lever 4 from the rest position to said pivoted position results in a rotation of the rod 40 from a stowed position to a position in which this rod 40 axially bears against the stop 6 and exerts a thrust force on the stop 6 towards the force sensor 5. For this, the rod 40 is rotatably movable about the horizontal axis H and pivots about the horizontal axis H in response to a force applied to the actuation lever 4.

In this embodiment, and as more particularly visible in FIG. 6, an end 400 of the rod 40 is capable of axially bearing against a portion 60 of said stop extending protruding at an end of the stop 6.

This rod 40 is here connected to the actuation lever 4 through drive means 41, 42. so that a rotation of the actuation lever 4 from the rest position to the pivoted position results in a rotation of the rod 40 and the drive means 41, 42 from a stowed position to a position in which the rod 40 axially bears against the stop 6 and exerts a thrust force on the stop 6 towards the force sensor 5.

As more particularly visible in FIG. 6, in this embodiment, the force sensor 5 is vertically spaced apart from the stop 6 such that a thrust exerted by the rod 40 on the stop 6 is detected from a predetermined value of bearing of the rod 40 against the stop 6.

For example, this predetermined value may be between 440N and 650 N.

So as to allow the deformation of the stop upon bearing by the rod 40, the stop 6 of this embodiment is at least partially made from deformable plastic or deformable metal.

When the pipetting head is not positioned in the predefined range of movement, it may be necessary, according to one embodiment, to hold the actuation lever backwards to prevent it from hitting the pipetting head for example and damaging it.

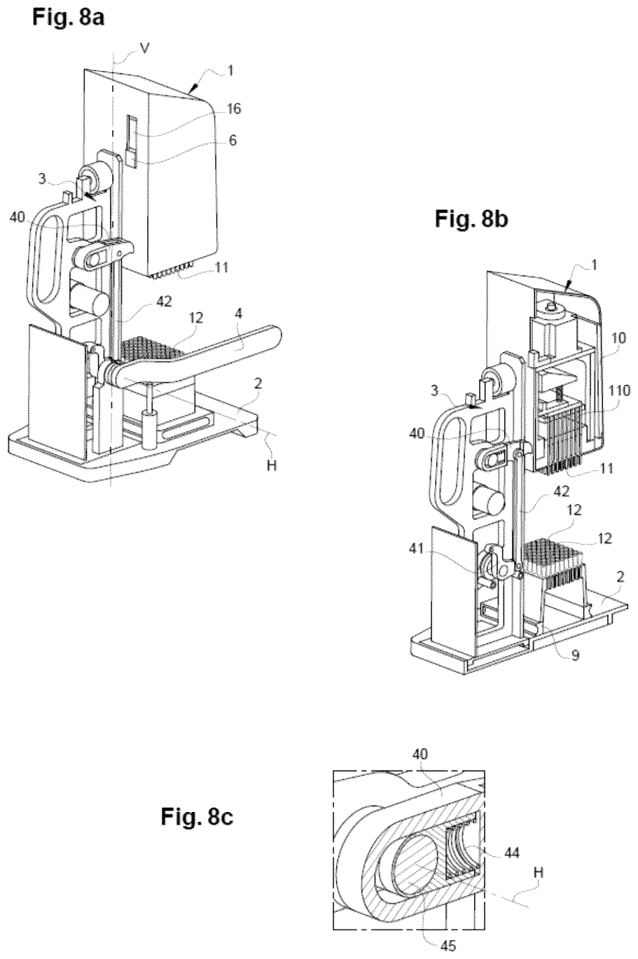

As a result, and as especially visible in FIGS. 7A to 8C, the pipetting system further comprises retraction means to move the rod 40 away when the pipetting head 1 is positioned outside the predefined range of movement. For example, the pipetting head can be positioned outside the predefined range of movement when the pipetting system is being installed, cleaned or maintained. It can also be positioned outside the range of movement when the pipetting system is switched off or in standby, these blocking means then preventing mishandling by a person passing by the pipetting system and pressing the actuation lever by mistake.

This position outside the range of movement can also be used to remove pipette cones from the rack, or to leave enough distance to install another consumable on the tray.

Thus, it is only when the pipetting head is correctly positioned in the predefined range of movement that the rod can axially bear against said stop when the actuation lever is rotated from the raised position to the pivoted position.

As illustrated in FIGS. 7A to 8C, the blocking means of this embodiment comprise a retraction spring 44 configured to exert a force towards a rotation pin 45 representing the horizontal axis H so as to move the rod 40 away from the pipetting head 1 when the pipetting head 1 is positioned outside the predefined range of movement.

This retraction spring is provided along an axis orthogonal to the horizontal axis H so that it produces a force along this axis orthogonal to the horizontal axis H. It is positioned in a recessed housing in the rod 40.

In this way, when the pipetting head is not positioned in the predefined range of movement, the rod is moved away and cannot rub against the casing 10 should the actuation lever be lowered, which would result in damaging the casing and the pipette head.

When the pipetting head is correctly positioned in the predefined range of movement, the window 16 provided in the casing 10 is located facing this rod 40 so that the stop 6 is accessible for this rod 40, this rod 40 can then exert a thrust force on the stop 6 towards the force sensor 5.

The pipetting system can also allow, in addition to having a control of the force for fitting the pipette cones onto the pipetting tips, more comprehensive tracking of the pipetting system and the different protocols in progress, so as to ensure, for example, that the protocol is properly carried out.

By protocol, it may especially be meant steps comprising actions of moving one or more elements, sampling, dispensing or mixing liquids sampled or dispensed, picking or ejecting pipette cones.

Thus, according to one embodiment, the pipetting system may comprise tracking means capable of delivering information belonging to the group comprising:
a number of pipette cones not yet used;
information relating to a protocol step to be performed, in progress, or performed;
information on the presence of a rack on said tray;
information relating to a value representative of a fitting force;
information on the date or time of completion of a fitting and/or pipetting;
a planned maintenance date;
identification information of consumables present on the tray;
identification information of the pipetting system.

To facilitate this tracking use, especially by a user, the pipetting system may comprise tracking means comprising a microcontroller and display means.

Thus, with the display of tracking information, a user can make decisions accordingly, perform required steps, stop the method for fitting the cones if a predefined value is displayed.

With this display, it is also possible to prevent a protocol step from being possible if the predefined cone fitting value is not reached. Such a prevention action can be carried out, for example, by blocking the movement of the pipetting motor.

These tracking means can also be used to ensure that the pipetting protocol has been properly carried out.

Thus, these tracking means can allow an action to be caused.

The system may also be provided with monitoring means, provided on the pipetting head 1 and to be positioned opposite the tray 9.

It should be noted that, according to an alternative, these monitoring means could also be provided on the tower.

These monitoring means could also be provided on or under the tray.

Such monitoring means may for example comprise a CCD or CMOS camera for checking the number of cone lines fitted, checking whether the consumable (which may be the pipette cone rack or the pipette cones) is present or absent from the tray, checking the position of the tray, checking actions carried out (picking of pipette cones, presence of liquid in consumables), or checking the type of tray installed in the case of a pipetting system having several removable or rotating trays.

The monitoring means may also for example be comprised of LEDs.

They may also be comprised of one or more accelerometers for monitoring the positioning or movement of one or more trays relative to the pipetting head.

This detection of the positioning of the tray can, for example, make it possible to adapt a fitting force setpoint to be achieved depending on whether only one or several rows of cones are positioned under the head and are to be fitted.

The system may also be provided with means for recognizing the racks 20 of pipette cones 12. Such recognition means may especially comprise a color sensor provided on the tower 3, facing the plate 9.

The system may also be provided with means for recognizing a liquid present in a container provided facing the tray 9.

The invention also relates to a method for fitting pipette cones 12 onto the pipetting system according to the invention.

This method comprises a step of pivoting the actuation lever 4 from a rest position to a pivoted position so as to transition the pipetting head 1 from the raised position in which the tips 11 are distant from the pipette cones 12 to the engaged position in which the pipette cones 12 are fitted onto the tips 11. It also comprises a step of checking an axial force along said vertical axis V for fitting said pipette cones 12 onto said tips 11.

It should be noted that, according to one embodiment, the step of checking a fitting force may comprise a step of emitting a signal when the fitting force reaches a predetermined threshold.

This signal may especially be a visual signal, such as the lighting of an LED of a certain color or a predefined number of LEDs, or an audible signal to alert that a predetermined threshold is reached so as not to damage the pipetting system.

This signal can also be a message displayed on the display means.

Such a signal can be useful to warn a user that they can release the lever.

The fitting method may also comprise a subsequent step of ejecting the pipette cones, once pipetting is carried out. Such a step may comprise a translation of the head along the vertical axis so as to move away from the plate, as well as a disengaging step.

The method may also comprise an initial step of positioning a rack comprising a plurality of pipette cones onto the tray. It may also comprise an initial step of inputting data into the tracking means.

This input data may for example comprise parameters such as a setpoint value to be reached to ensure the correct fitting of the pipette cones, depending on the type of cones that has been chosen by an operator.

These parameters may also comprise parameters for driving the system, which can for example allow establishing a pipetting protocol, setting a volume of liquid to be sampled or dispensed, setting a pipetting speed.

It should be noted that this initial input step can be manually performed by an operator via a graphical interface for driving the pipetting system.

The input could also be partially automatic, for example by taking account of different information collected by sensors in the pipetting system.

1-16. (canceled)

17. A pipetting system comprising:
a rack comprising a plurality of pipette cones, the rack being arranged on a rectangular matrix of rows and columns;
a pipetting head comprising a casing housing a plurality of pipetting channels arranged on the rectangular matrix of rows and columns, each of said plurality of pipetting channels being provided with a tip to cooperate with one of said plurality of pipette cones by a fitting so as to receive or dispense a liquid, the pipetting head being movable in a predefined range of movement between a raised position in which the tips are distant from said plurality of pipette cones and an engaged position in which said plurality of pipette cones are fitted onto the tips;
a base comprising at least one tray facing the pipetting head and configured to accommodate the rack;
a tower extending from the base and comprising a linear guide rail along which the pipetting head is manually moveable along a vertical axis relative to the base in the predefined range of movement;
an actuation lever rotatably mounted along a horizontal axis orthogonal to the vertical axis relative to the base, the actuation lever being configured to vertically translationally drive the pipetting head between the raised position and the engaged position in response to a force applied to the actuation lever, the actuation lever being rotatably movable between at least a rest position and a pivoted position so as to transition the pipetting head from the raised position to the engaged position; and
a force sensor to check an axial fitting force along the vertical axis for fitting said plurality of pipetting cones onto the tips caused by a rotation of the actuation lever between the rest position and the pivoted position.

18. The pipetting system of claim 17, further comprising a stop configured to at least partially bear against the force sensor in response to at least partial rotation of the actuation lever from the rest position to the pivoted position.

19. The pipetting system of claim 18, wherein the tower further comprises a rod to pick up a movement of the actuation lever, the rod being connected to the actuation lever by a driver, the rod being rotatably movable about the horizontal axis and pivoting about the horizontal axis in response to the force applied to the actuation lever, so that the rotation of the actuation lever from the rest position to the pivoted position results in a rotation of the rod and the driver from a stowed position to a position in which the rod axially bearing against the stop exerts a thrust force on the stop towards the force sensor.

20. The pipetting system of claim 19, wherein the force sensor is vertically spaced apart from the stop so that the thrust force exerted by the rod on the stop is detected from a predetermined value of bearing of the rod against the stop.

21. The pipetting system of claim 19, further comprising a retraction spring to move the rod away from the pipetting head, when the pipetting head is positioned outside the predefined range of movement.

22. The pipetting system of claim 21, wherein the retraction spring is configured to exert a force towards a rotation pin representing the horizontal axis so as to move the rod away from the pipetting head, when the pipetting head is positioned outside the predefined range of movement.

23. The pipetting system of claim 18, further comprising a microcontroller provided on the pipetting head or the tower, and the microcontroller being positioned opposite said at least one tray.

24. The pipetting system of claim 18, wherein the stop is at least partially made from a deformable plastic or a deformable metal.

25. The pipetting system of claim 17, further comprising a pipetting motor to receive or dispense the liquid into liquid sampling or receiving containers disposed on said at least one tray, and to eject spent pipette cones.

26. The pipetting system of claim 17, further comprises a color sensor to recognize the rack.

27. The pipetting system of claim 26, wherein the color sensor is provided on the tower facing said at least one tray.

28. The pipetting system of claim 17, further comprising a microcontroller configured to deliver information on a display, the information comprising at least one of the following:
a number of pipette cones not yet used;
information relating to a protocol step to be performed, in progress, or performed;
information on a presence of the rack on said at least one tray;
information relating to a value representative of an axial fitting force;
information on a date or time of completion of at least one of fitting and pipetting;
a planned maintenance date;
identification information of consumables present on said at least one tray; and
identification information of the pipetting system.

29. A method for fitting said plurality of pipette cones onto a pipetting system of claim 17, the method comprising:
pivoting the actuation lever from the rest position to the pivoted position so as to transition the pipetting head from the raised position to the engaged position; and
checking the axial fitting force along the vertical axis for fitting said plurality of pipetting cones onto the tips.

30. The method of claim 29, further comprising emitting a signal when the axial fitting force reaches a predetermined threshold.
